(19) United States
(12) Patent Application Publication
(10) Pub. No.: US 2023/0160856 A1
(43) Pub. Date: May 25, 2023

(54) LASER-BASED WELD INSPECTION METHOD AND SYSTEM

(71) Applicant: TECNAR AUTOMATION LTEE, St-Bruno (CA)

(72) Inventors: Morgan James HIRAIWA, St-Bruno (CA); Thomas GARCIN, St-Bruno (CA); Vincent MARTEL CARBONNEAU, St-Bruno (CA); Marc CHOQUET, St-Bruno (CA); Alexandre NADEAU, St-Bruno (CA)

(21) Appl. No.: 17/996,838

(22) PCT Filed: Jun. 22, 2021
(86) PCT No.: PCT/CA2021/050852

§ 371 Date: Oct. 21, 2022

Related U.S. Application Data
(60) Provisional application No. 63/108,585, filed on Nov. 2, 2020.

(51) Int. Cl. G01N 29/12; G01N 29/11; G01N 29/24; G01N 29/46; G01N 29/44

(52) U.S. Cl. CPC G01N 29/12; G01N 29/11; G01N 29/2418; G01N 29/46; G01N 29/4427; G01N 2291/267; G01N 2291/0289

(57) ABSTRACT

Methods and systems for inspecting a weld area between a first and a second metallic sheet are provided an acoustic wave is generated in the first metallic sheet for propagation towards the second metallic sheet, across the weld area. A weld quality indicator is obtained. In some variants, the weld quality indicator is obtained from a comparison of first and second sheet time-varying signals representative of a surface motion in the first and second metallic sheets. In some variants, the weld quality indicator is based on the frequency-dependent attenuation of the acoustic wave in the second metallic sheet.

### TECHNICAL FIELD

The technical field generally relates to inspection of welds and more particularly concerns methods and systems for the accurate determination of quality based on an analysis of an acoustic wave propagating through the weld.

### BACKGROUND

Real-time inspection of overlap welding processes can reduce manufacturing downtime due to coil joining failures. Existing instruments capable of volumetric inspection of subsurface defects rely on either piezoelectric elements that require direct contact of a coupling medium, or electro-magnetic acoustic transducers that must be in close proximity to the object of interest. Detection of flaws is however limited to voids or cracks within the weld.

There remains a need for improved methods and systems providing a qualification of defects in welds.

### SUMMARY

In accordance with one aspect, there is provided a method for inspecting a weld area between a first and a second metallic sheet. The method comprises:
a) generating an acoustic wave in the first metallic sheet for propagation towards the second metallic sheet across the weld area;
b) measuring a frequency content of the acoustic wave in the second metallic sheet;
c) determining a frequency-dependent attenuation of the acoustic wave from the measured frequency content of the acoustic wave in the second metallic sheet; and
d) determining a weld quality indicator based on said frequency-dependent attenuation.

In some implementations, measuring a frequency content of the acoustic wave in the second metallic sheet comprises obtaining a second sheet time-varying signal proportional to an out-of-plane displacement of a top surface of the second metallic sheet through time-domain light interferometry; and determining a frequency-dependent attenuation of the acoustic wave comprises analysing said second sheet time-varying signal in the frequency domain.

In some implementations, analysing said second sheet time-varying signal in the frequency domain comprises calculating a power spectral density curve of said second sheet time-varying signal.

In some implementations, analysing said second sheet time-varying signal in the frequency domain comprises fitting the power spectral density curve to a power law, and determining an exponent value of said power law.

In some implementations, the weld quality indicator is a weld nugget size, and determining said weld quality indicator comprises comparing said exponent value of the power law to a calibrated exponent threshold, and, if said exponent value is greater than the calibrated exponent threshold, indicating a presence of large grains in the weld area.

In some implementations, the method further comprises measuring a frequency content of the acoustic wave in the first metallic sheet, and wherein determining the frequency-dependent attenuation of the acoustic wave comprises comparing the measured frequency contents of the acoustic wave in the first and second metallic sheets.

In some implementations, measuring a frequency content of the acoustic wave in the first and second metallic sheet comprises obtaining a first and a second sheet time-varying signal each proportional to an out-of-plane displacement of a top surface of the respective one of the first and second metallic sheets through time-domain light interferometry; and determining a frequency-dependent attenuation of the acoustic wave comprises analysing said first and second sheet time-varying signals in the frequency domain.

In some implementations, analysing said first and second sheet time-varying signals in the frequency domain comprises calculating a first and a second power spectral density curve of said first and second sheet time-varying signals, respectively.

In some implementations, analysing said first and second sheet time-varying signals in the frequency domain comprises:
identifying a plurality of vibration modes in the first and second spectral density curves;
determining an amplitude ratio of each of said vibration modes in the first metallic sheet and in the second metallic sheet; and
fitting the amplitude ratio as a function of frequency to a power law, and determining an exponent value of said power law.

In some implementations, the weld quality indicator is a weld nugget size; determining said weld quality indicator comprises comparing said exponent value of the power law to a calibrated exponent threshold; and if said exponent value is greater than the calibrated exponent threshold, indicating a presence of large grains in the weld area.

In some implementations, the method further comprises determining a total transmitted energy into the second metallic sheet through integration of the power spectral density curve of the second sheet time-varying signal, comparing said total transmitted energy to a calibrated transmitted energy threshold, and if said total transmitted energy is lower than the calibrated transmitted energy threshold, indicating a presence of a fusion defect in the weld area.

In some implementations, the method further comprises:
determining a total transmitted energy into the second metallic sheet through a comparison of the second power spectral density curve and the first spectral density curve; and
comparing said total transmitted energy to a calibrated transmitted energy threshold, and if said total transmitted energy is lower than the calibrated transmitted energy threshold, indicating a presence of a fusion defect in the weld area.

In some implementations, the method further comprises comparing the first and a second sheet time-varying signals to detect a phase shift therebetween, an upon detection of said phase shift, indicating a presence of a fusion defect in the weld area.

In accordance with another aspect, there is a provided a system for inspecting a weld area between a first and a second metallic sheets, comprising:
an acoustic wave generator for generating an acoustic wave in the first metallic sheet for propagation towards the second metallic sheet across the weld area;
a second sheet acoustic detection assembly positioned to measure a surface motion at a second sheet detection location in the second metallic sheet and configured to measure a frequency content of the acoustic wave in the second metallic sheet, the second sheet acoustic detection assembly comprising a transmitted-wave interferometer; and
a processor configured to determine a frequency-dependent attenuation of the acoustic wave from a frequency contents of the acoustic wave in the second metallic sheet, and determine a weld quality indicator based on said frequency contents of the acoustic wave in the second metallic sheet.

In some implementations, the acoustic wave generator comprises a wave generation laser source emitting a pulsed laser beam impinging on a generation spot on or in the first metallic sheet.

In some implementations, the second sheet acoustic detection assembly comprises:
a second sheet detection laser source configured to generate a transmitted-wave detection light beam propagating along a second sheet illumination path towards the second sheet detection location, the transmitted-wave interferometer receiving a portion of the transmitted-wave detection light beam from the second sheet detection laser source and a portion of the transmitted-wave detection light beam reflected on a top surface of the second metal sheet and travelling along a second sheet collection path; and
a photodetector coupled to the transmitted wave interferometer and producing a second sheet time-varying signal proportional to an out-of-plane displacement of the top surface of the second metallic sheet.

In some implementations, the processor is configured to analyse said second sheet time-varying signal in the frequency domain to determine the frequency-dependent attenuation of the acoustic wave.

In some implementations, analysing said second sheet time-varying signal in the frequency domain comprises:
calculating a power spectral density curve of said second sheet time-varying signal and
fitting the power spectral density curve to a power law, and determining an exponent value of said power law; and
   wherein the weld quality indicator is a weld nugget size; and
   wherein determining said weld quality indicator comprises comparing said exponent value of the power law to a calibrated exponent threshold, and, if said exponent value is greater than the calibrated exponent threshold, indicating a presence of large grains in the weld area.

In some implementations, the system further comprises a first sheet acoustic detection assembly positioned to measure surface motion at a first sheet detection location in the first metallic sheet, before the weld zone, thereby obtaining information on the acoustic wave as propagating in the first metallic sheet.

In some implementations, the first sheet acoustic detection assembly comprises:
a first sheet detection laser source configured to generate a generated-wave detection light beam propagating along a first sheet illumination path towards the first sheet detection location;
a generated-wave interferometer receiving a portion of the generated-wave detection light beam from the first sheet detection light source and a portion of the generated-wave detection light beam reflected on a top surface of the first metal sheet and travelling along a first sheet collection path; and
a photodetector coupled to the generated-wave interferometer and producing a first sheet time-varying signal proportional to an out-of-plane displacement of the top surface of the first metallic sheet.

In some implementations, the processor is configured to analyse said first and second sheet time-varying signals in the frequency domain to determine the frequency-dependent attenuation of the acoustic wave.

In some implementations, analysing said first and second sheet time-varying signals in the frequency domain comprises:
calculating a first and a second power spectral density curve of said first and second time-varying signals, respectively;
identifying a plurality of vibration modes in the first and second spectral density curves;
determining an amplitude ratio of each of said vibration modes in the first metallic sheet and in the second metallic sheet; and
fitting the amplitude ratio as a function of frequency to a power law, and determining an exponent value of said power law;
   wherein the weld quality indicator is a weld nugget size; and
   wherein determining said weld quality indicator comprising comparing said exponent value of the power law to a calibrated exponent threshold, and if said exponent value is greater than the calibrated exponent threshold, indicating a presence of large grains in the weld area.

In accordance with another aspect, there is provided a system for inspecting a weld area between a first and a second metallic sheets, comprising:
an acoustic wave generator for generating an acoustic wave in the first metallic sheet for propagation towards the second metallic sheet across the weld area;
a first sheet acoustic detection assembly configured to obtain a first sheet time-varying signal representative of a surface motion at a first sheet detection location in the first metallic sheet;
a second sheet acoustic detection assembly configured to obtain a second sheet time-varying signal representative of a surface motion at a second sheet detection location in the second metallic sheet; and
a processor configured to determine a weld quality indicator based on a comparison of said first and second sheet time-varying signals.

In some implementations, the acoustic wave generator comprises a wave generation laser source emitting a pulsed laser beam impinging on a generation spot on or in the first metallic sheet.

In some implementations, the first sheet acoustic detection assembly comprises:
a first sheet detection laser source configured to generate a generated-wave detection light beam propagating along a first sheet illumination path towards the first sheet detection location;
a generated-wave interferometer receiving a portion of the generated-wave detection light beam from the first sheet detection light source and a portion of the generated-wave detection light beam reflected on a top surface of the first metal sheet and travelling along a first sheet collection path; and
a photodetector coupled to the generated-wave interferometer and producing the first sheet time-varying signal.

In some implementations, the second sheet acoustic detection assembly comprises:
a second sheet detection laser source configured to generate a transmitted-wave detection light beam propagating along a second sheet illumination path towards the second sheet detection location;
a transmitted-wave interferometer receiving a portion of the transmitted-wave detection light beam from the second sheet detection laser source and a portion of the transmitted-wave detection light beam reflected on a top surface of the second metal sheet and travelling along a second sheet collection path; and
a photodetector coupled to the transmitted-wave interferometer and producing the second sheet time-varying signal.

In some implementations, the processor is configured to:
determine a total transmitted energy into the second metallic sheet from a comparison of the first and second time-varying signal, and
compare said total transmitted energy to a calibrated transmitted energy threshold, and if said total transmitted energy is lower than the calibrated transmitted energy threshold, indicating a presence of a fusion defect in the weld area.

In some implementations, the processor is configured to compare the first and the second sheet time-varying signals to detect a phase shift therebetween, an upon detection of said phase shift, indicating a presence of a fusion defect in the weld area.

In accordance with yet another implementation, there is provided a method for inspecting a weld area between a first and a second metallic sheet, comprising:
a) generating an acoustic wave in the first metallic sheet for propagation towards the second metallic sheet across the weld area;
b) obtaining a first sheet time-varying signal representative of a surface motion at a first sheet detection location in the first metallic sheet;
c) obtaining a second sheet time-varying signal representative of a surface motion at a second sheet detection location in the second metallic sheet; and
d) determining a weld quality indicator based on a comparison of said first and second sheet time-varying signals.

In some implementations, generating an acoustic wave comprises impinging a pulsed laser beam on a generation spot on or in the first metallic sheet.

In some implementations, obtaining a first sheet time-varying signal comprises:
propagating a generated-wave detection light beam along a first sheet illumination path towards the first sheet detection location;
receiving, in a generated-wave interferometer, a portion of the generated-wave detection light beam from the first sheet detection light source and a portion of the generated-wave detection light beam reflected on a top surface of the first metal sheet and travelling along a first sheet collection path; and
detecting the first sheet time-varying signal as produced by the generated-wave interferometer.

In some implementations, obtaining a second sheet time-varying signal comprises:
propagating a transmitted-wave detection light beam along a second sheet illumination path towards the second sheet detection location;
receiving, in a transmitted-wave interferometer, a portion of the transmitted-wave detection light beam from the second sheet detection laser source and a portion of the transmitted-wave detection light beam reflected on a top surface of the second metal sheet and travelling along a second sheet collection path; and
detecting the second sheet time-varying signal as produced by the transmitted-wave interferometer.

In some implementations, determining a weld quality indicator based on a comparison of said first and second sheet time-varying signals comprises:
determining a total transmitted energy into the second metallic sheet from a comparison of the first and second time-varying signal, and
comparing said total transmitted energy to a calibrated transmitted energy threshold, and if said total transmitted energy is lower than the calibrated transmitted energy threshold, indicating a presence of a fusion defect in the weld area.

In some implementations, determining a weld quality indicator based on a comparison of said first and second sheet time-varying signals comprises comparing the first and a second sheet time-varying signals to detect a phase shift therebetween, an upon detection of said phase shift, indicating a presence of a fusion defect in the weld area.

In accordance with one aspect, there is provided a method for inspecting a weld area between a first and a second metallic sheets, comprising:
a) generating an acoustic plate wave in the first metallic sheet for propagation towards the second metallic sheet across the weld area;
b) measuring a frequency content of the acoustic plate wave in the second metallic sheet;
c) determining a frequency-dependent attenuation of the acoustic plate wave from the measured frequency contents of the acoustic plate wave in the second metallic sheet; and
d) determining a weld quality indicator based on said frequency contents of the acoustic plate wave in the second metallic sheet.

In accordance with one aspect, there is provided a method for inspecting a weld area between a first and a second metallic sheets, comprising:
a) generating an acoustic plate wave in the first metallic sheet for propagation towards the second metallic sheet across the weld area;
b) measuring a frequency content of the acoustic plate wave in the first metallic sheet;
c) measuring a frequency content of the acoustic plate wave in the second metallic sheet;
d) determining a frequency-dependent attenuation of the acoustic plate wave in the second metallic sheet from the measured frequency contents of the acoustic plate wave in the first and second metallic sheet; and
e) determining a weld quality indicator based on said frequency contents of the acoustic plate wave in the second metallic sheet.

In accordance with one aspect, there is provided a system for inspecting a weld area between a first and a second metallic sheets, comprising:
an acoustic wave generator for generating an acoustic plate wave in the first metallic sheet for propagation towards the second metallic sheet across the weld area;
a second sheet acoustic detection assembly positioned to measure surface motion at a second sheet detection location in the second metallic sheet measuring a frequency content of the acoustic plate wave in the second metallic sheet, the second sheet acoustic detection assembly comprising a transmitted-wave interferometer;
a processor configured to determine a frequency-dependent attenuation of the acoustic plate wave from a frequency contents of the acoustic plate wave in the second metallic sheet, and determine a weld quality indicator based on said frequency contents of the acoustic plate wave in the second metallic sheet.

In some variants the system may further include a first sheet acoustic detection assembly positioned to measure surface motion at a first sheet detection location in the first metallic sheet and determine a frequency content of the acoustic plate wave in the first metallic sheet, the second sheet acoustic detection assembly comprising a generated-wave interferometer. The processor may be further configured to determine the frequency-dependent attenuation of the acoustic plate wave from a frequency contents of the acoustic plate wave in the both the first and second metallic sheet.

Advantageously, embodiments of the systems described here improve upon existing equipment by enabling a larger working distance, broadband generation of more modes, and analysis of weld microstructure. In some implementations non-contact and large stand-off distance allows for material inspection at elevated temperatures, which may be critical during real-time weld defect detection.

Other features and advantages will be better understood upon a reading of the description of embodiments with reference to the appended drawing.

### BRIEF DESCRIPTION OF THE DRAWINGS

FIG. 1 is a schematized representation of a system for inspecting a weld area between a first and a second metallic sheet according to some embodiments.

FIG. 2A is a graph of a time-varying signal proportional to an out-of-plane displacement of the top surface of the second metallic sheet obtained through time-domain light interferometry in one example of implementation; FIG. 2B is a graph of the power spectral density (PSD) curve of the second sheet time-varying signal of FIG. 2A.

FIG. 3A is a graph of a time-varying signal proportional to an out-of-plane displacement of the top surface of the first metallic sheet obtained through time-domain light interferometry in one example of implementation; FIG. 3B is a graph of the power spectral density (PSD) curve of the first sheet time-varying signal of FIG. 3A.

FIG. 4 is a graph of the ratio of the selected modes shown in FIG. 3B in the first and second sheets fit to a power-law curve.

FIG. 5 compares the time domain signals obtained from one sample containing defects, and two samples with no defects observed.

FIG. 6 is a schematized representation of system for inspecting a weld area between a first and a second metallic sheet according one implementation.

FIG. 7 is a flow chart of a method according to one embodiment.

FIG. 8 is a flow chart of a method according to another embodiment.

### DETAILED DESCRIPTION

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the present description, when a broad range of numerical values is provided, any possible narrower range within the boundary of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

In accordance with some implementations, there are provided methods and systems for inspecting a weld area between a first and a second metallic sheet. Embodiments can provide the non-contact laser ultrasonic on-line inspection of joint welds.

Implementations of the methods and systems described herein may be useful in a variety of applications where metallic sheets are joined together by welding, such as for example continuous galvanizing, continuous annealing, cold rolling, continuous pickling lines, etc.

### Method

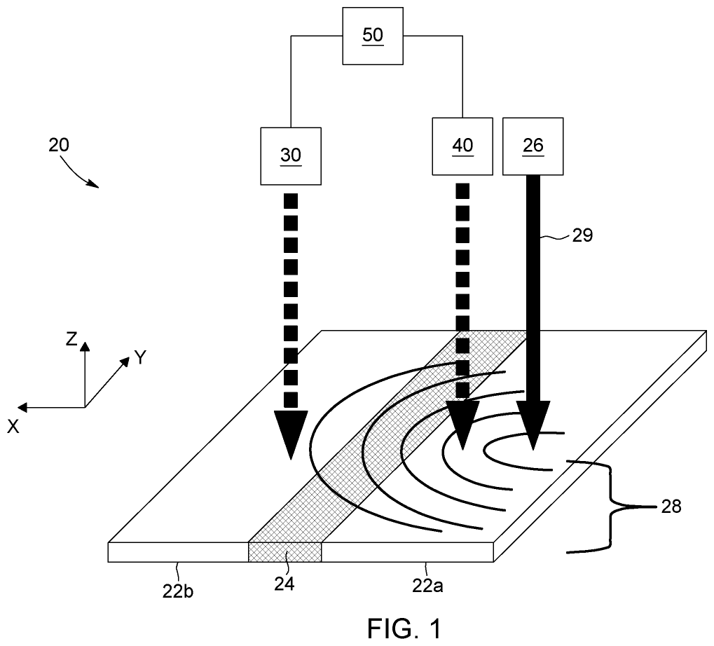

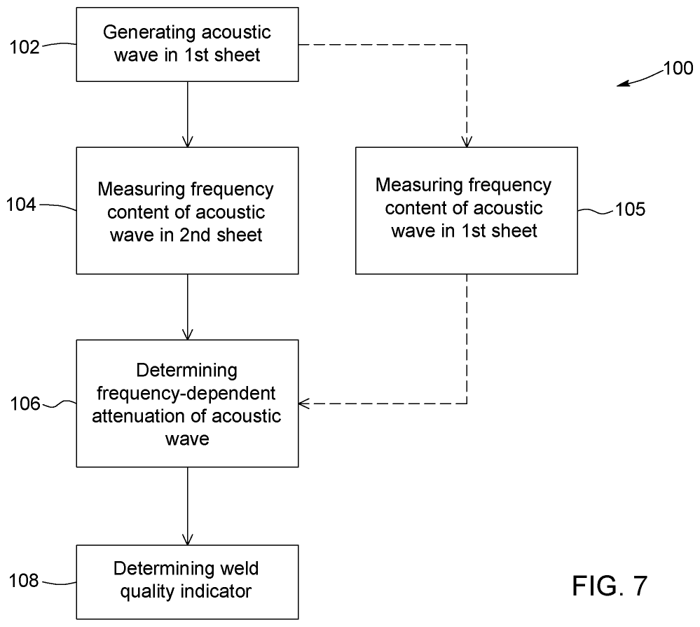

With reference to FIGS. 1 and 7, a weld inspection system 20 and method 100 according to some implementations are broadly illustrated.

As mentioned above, the system 20 and method 100 provide for the inspection of a weld area 24 between a first metallic sheet 22a and a second metallic sheets 22b. The weld area 24 may define either a butt joint-type weld or a lap joint-type weld. As understood by those skilled in the art, butt joint-type welds refer to the joining of coplanar metallic sheets along their co-extending edges. Lap joint-type welds typically refer to the joining of parallel metallic sheets along a thin overlapping section where one of the sheets lies over the other.

By convention, in the illustrated implementation of FIG. 1, the metallic sheets 22a and 22b define a X-Y plane with the weld area 24 extending along the Y direction, and a Z direction transversal to the plane of the metallic sheets. It will be readily understood that the X-Y-Z reference system is used herein for ease of reference only and is not meant as limitative to the scope of protection.

The method 100 first includes a step of generating 102 an acoustic wave 28 in the first metallic sheet 22a for propagation towards the second metallic sheet 22b across weld area 24. It will be understood that the designations of “first” and “second” sheets are used in reference to the direction of propagation of the acoustic wave 28, and are not meant to impart any preferential characteristics to one of the sheets with respect to the other.

In some embodiments, the acoustic wave is or includes an acoustic plate wave. The expression “acoustic plate wave” or alternatively “guided Lamb wave”, is understood to refer to an elastic acoustic wave confined within a plate, such that energy propagates in directions within the plane of a plate, here the X-Y plane of the first sheet 22a. In other variants, the acoustic wave could be or include a longitudinal sheer or surface wave. In typical embodiments, the acoustic wave is a mix of different types of waves. In some implementations, the acoustic wave 28 is generated by photoacoustic effect, that is, through the interaction of light from a pulsed light beam 29 with the medium of the first metal sheet 22a. The acoustic wave 28 is generated in the first sheet 22a and guided therein towards the weld zone 24 and the second sheet 22b, along the X direction in the reference convention of FIG. 1. Upon reaching the weld area 24, the acoustic wave 28 may either be transmitted through the weld area 24 to the second metallic sheet 22b, or reflected or scattered back in the first metallic sheet 22a.

In accordance with some implementations, welds can be qualified according to two metrics, namely incomplete fusion and insufficient weld nugget size, described as follows.

Incomplete fusion produces large voids between the two metallic sheets being joined, which leads to a reflection of a portion of the acoustic energy of the acoustic wave 28 back in the first sheet 22a. Large voids can therefore be expected to reduce the amount of total energy transmitted from the first metallic sheet 22a to the second metallic sheet 22b. In the extreme case of zero fusion or contact, negligible energy will be transmitted, with nearly complete reflection. Identification of this type of flaw may therefore be achieved by quantifying total energy transmission of the acoustic wave through the weld zone 24 into the second metallic sheet 22b.

The other type of defects arise in cases where complete fusion has occurred, but the weld nugget, formed by the melting and subsequent solidification of the metal near the interface between the two metallic sheets, is smaller than desired and may cause failure upon application of a tensile load. One indication of this type of flaw can be found through a microstructural analysis of the weld, that is, a detection and sizing of weld nuggets. The lower welding temperatures typically resulting in a small weld nugget also produce smaller crystalline grains due to restricted dislocation migration. By contrast, the higher temperature that produces large weld nuggets allows for greater dislocation migration and subsequent grain growth. A large, high quality weld nugget is associated with large crystalline grains within the nugget and can be analyzed in the frequency domain due to the frequency-dependent attenuation of the acoustic wave plate caused by grain scattering. For grains that are of a similar size or smaller than the acoustic wavelengths of the acoustic wave, grain scattering causes greater attenuation for higher frequencies.

Therefore, observing relatively greater attenuation at high frequencies compared to low frequencies is a signature of large grains and a high-quality weld nugget was has reached high temperatures during the welding process. In some variants, because attenuation resulting from grain scattering follows a power-law dependence on frequency, the measured data can be fit using an equation of the same form.

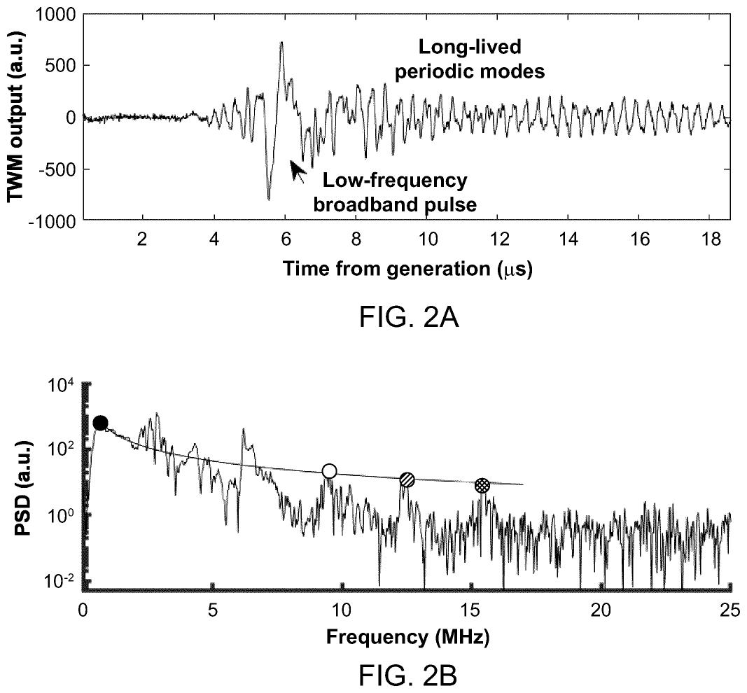

In some implementations, the method 100 for inspecting a weld area includes a step of measuring 104 a frequency content of the acoustic wave in the second metallic sheet, and determining 106 a frequency-dependent attenuation of the acoustic wave from the measured frequency content of the acoustic wave in the second metallic sheet. Referring to FIG. 1, propagation of the acoustic wave 28 along the plane of the first and second metal sheets 22a and 22b leads to surface motion at the top surface 23a, 23b of the corresponding metal sheet, which can be detected and measured, for example through time-domain light interferometry. In some variants, the measuring of a frequency content of the acoustic wave in the second metallic sheet therefore includes obtaining a second sheet time-varying signal proportional to the out-of-plane displacement of the top surface of the second metallic sheet through time-domain light interferometry. The frequency-dependent attenuation of the acoustic wave is then obtained by analysing the second sheet time-varying signal in the frequency domain. Referring to FIG. 2A, an example of a time-varying signal obtained at the interferometric output for a detection location in the second metallic sheet, hence after the weld, is shown. The time-varying signal can be approximately thought of as a superposition of two categories of ultrasonic waves: 1) a transient low frequency broadband pulse that arrives toward the front of the signal and 2) long-lived higher frequency periodic modes. Because the time-varying signal contains different modes, analysis in the frequency domain is useful. In some implementations, to analyse the second sheet time-varying signal in FIG. 2A in the frequency domain, a power spectral density (PSD) curve of the second sheet time-varying signal is calculated, as shown in FIG. 2B. In the frequency domain analysis, the different modes are clearly visible as peaks. The lowest frequency content is substantially broadband, while several periodic modes are observed as sharp peaks at higher frequencies.

In some implementations, the method includes determining 108 a weld quality indicator based on the frequency-dependent attenuation of the acoustic wave obtained from the steps above, that is, from measuring the transmitted acoustic wave in the second metallic sheet only. This “single detection spot” scheme may be of particular interest in applications where the frequency-domain amplitude of various modes being generated does not vary significantly. Such a scenario is aided by uniform reflectivity and chemical composition of the surface at the location of generation of the acoustic wave. In some embodiments, analysing the second sheet time-varying signal in the frequency domain may involve fitting the power spectral density curve to a power law, and determining an exponent value of this power law. By way of example the frequency dependent attenuation of the acoustic plate may be estimated by least squares fitting a power-law curve of the form a·f^{-b} to the peaks of the PSD, wherein ‘a’ and ‘b’ are fitted constants and ‘f’ is frequency. According to this equation, greater attenuation at high frequencies will result in b becoming larger. In general, the choice of which modes to include in the fit can depend on the application. FIG. 2B shows the curve fit to the peak of the broadband low frequency peak and periodic modes #3-5. In some implementations, the weld quality indicator is a weld nugget size the determining of the weld quality indicator involves comparing the exponent value of the power law to a calibrated exponent threshold. If the exponent value is greater than the calibrated exponent threshold, the presence of large grains in the weld area can be indicated or reported. The calibrated exponent threshold may for example be obtained from a calibration sample of known quality.

In some implementations the method 100 may involve determining the frequency-dependent attenuation of the acoustic wave in the second metallic sheet from the measured frequency contents of the acoustic wave in both the first and second metallic sheet. This embodiment may for example be of interest in implementations where generation is inconsistent, as determining the attenuation may require comparing the amplitude of each mode after the weld to the amplitude before the weld. This situation is especially common for materials with variable surface condition such as an oil coating. In some embodiment, the method may therefore include a step of measuring 105 a frequency content of the acoustic wave in the first metallic sheet. This may be achieved by obtaining a first sheet time-varying signal each proportional to an out-of-plane displacement of a top surface of the first metallic sheet through time-domain light interferometry. The frequency-dependent attenuation of the acoustic wave then involves comparing the measured frequency contents of the acoustic wave in the first and second metallic sheets. In some variants, the first and second sheet time-varying signals are analysed in the frequency domain. For example, a first and a second power spectral density curve of the first and second sheet time-varying signals, respectively, may be calculated. In some implementations, the method then includes identifying a plurality of vibration modes in the first and second spectral density curves, determining an amplitude ratio of each of these vibration modes in the first metallic sheet and in the second metallic sheet, fitting the amplitude ratio as a function of frequency to a power law, and determining an exponent value of said power law.

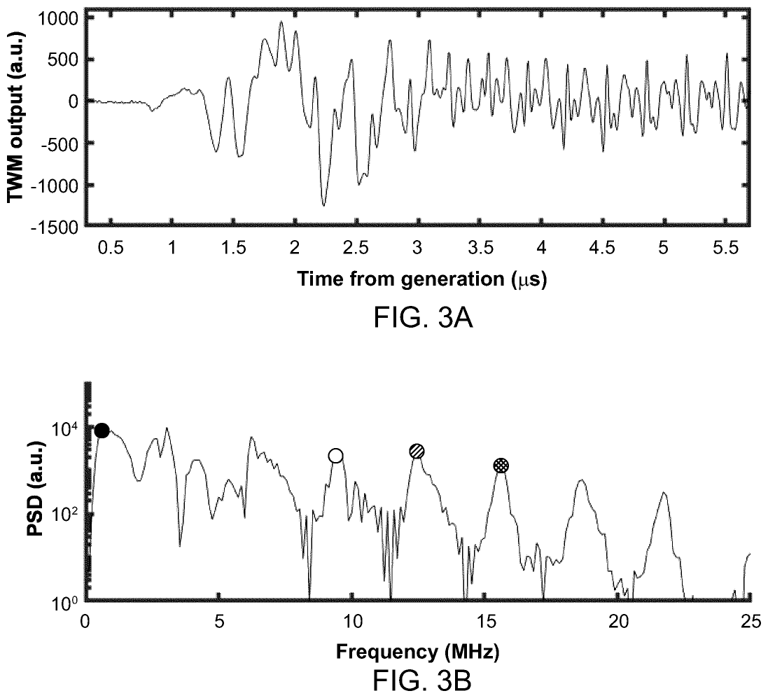

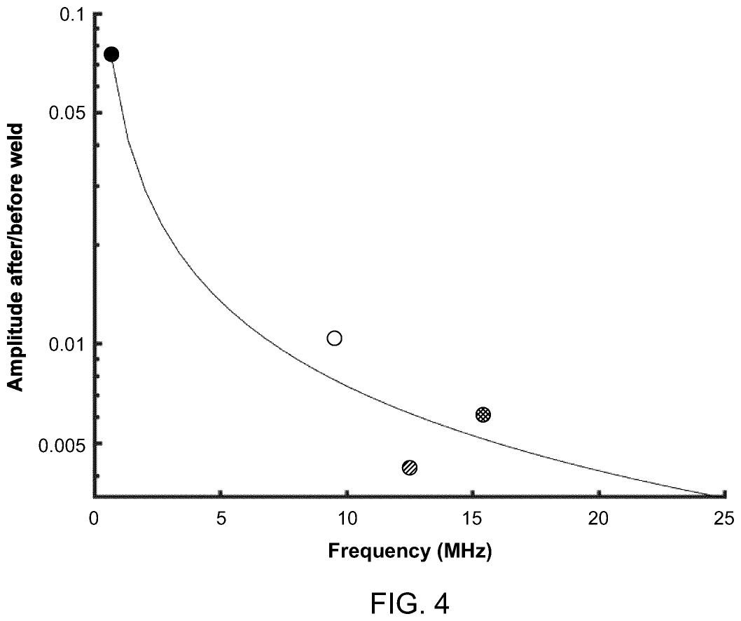

Examples of a time domain signal before the weld, and the associated PSD of this signal, are shown in FIGS. 3A and 3B. In this example, the attenuation may then be characterized by taking the ratio the amplitude of each mode after the weld and dividing it by the amplitude of the same mode before the weld. The ratio of the selected modes is then fit to a power-law curve as shown in by way of example in FIG. 4, using the same modes selected for the fit in FIG. 3B. Just as in the single detection spot scheme, the power-law exponent ‘b’ from the fit is then compared to a calibrated exponent threshold, for example obtained from a calibration sample. If the exponent value ‘b’ is greater than the calibrated exponent threshold, this indicates the presence of large grains in the weld area, and the weld nugget size can be used as a weld quality indicator.

In addition to the analyzing of the weld nugget size as a quality indicator, in some embodiments the method may include the evaluation of defects such as cracks and voids, which are other known factors relevant to the mechanical integrity of a weld. These defects act as individual localized reflecting surfaces to the acoustic wave, as opposed to grain scattering wherein many randomly oriented grain interfaces scatter energy in all directions, and therefore a different analysis is employed for defect detection.

For large defects, i.e. when the voids are large, a significant amount of energy is reflected back in the first metallic sheet towards the generation site, and the amount of energy transmitted across the weld decreases accordingly. In the extreme case of no weld fusion and zero contact between parts, no energy is transmitted. In some implementations, the method may include a step of determining a total transmitted energy into the second metallic sheet through integration of the power spectral density curve of the second sheet time-varying signal, and comparing this total transmitted energy to a calibrated transmitted energy threshold. If the total transmitted energy is lower than the calibrated transmitted energy threshold, the presence of a fusion defect in the weld area in indicated.

In one example of implementation, determining the presence of large defects is accomplished by integrating the PSD of the signal detected in the second metallic sheet, up till a limit determined by the detector bandwidth to find the total energy transmitted. When the total energy transmitted is below a threshold obtained on a calibration sample, an alert indicating that a defect is present at that location of the weld may be generated.

In another example of implementation, determining the total transmitted energy into the second metallic sheet may be accomplished through a comparison of the second power spectral density curve and the first spectral density curve. For environments and materials that cause inconsistent ultrasound generation, such that a dual detection spot scheme is used, the lack of energy transmitting can be corroborated by comparing the transmitted ultrasound energy measured after the weld to the generated ultrasound energy before weld. Alternatively, constant ‘a’ from the weld nugget analysis power-law fit can be used instead, since this is related to the average of the mode amplitudes being used in the fit.

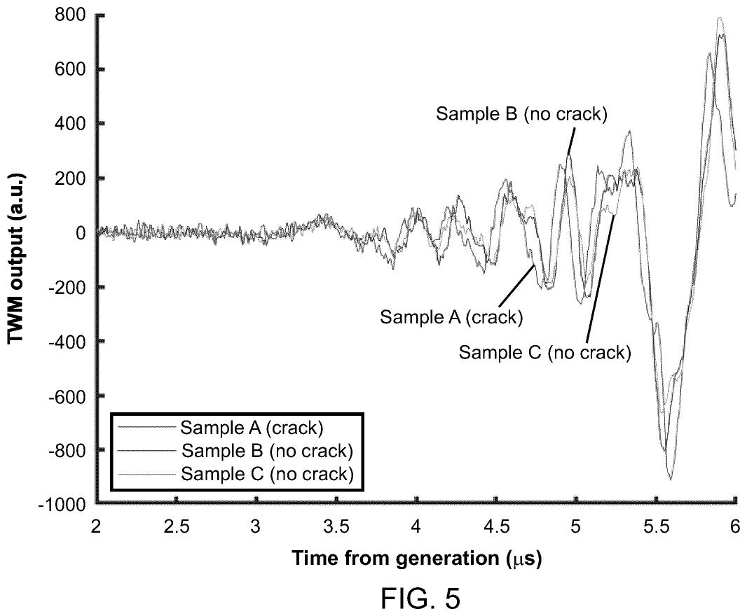

In some implementations, the method may include comparing the first and a second sheet time-varying signals to detect a phase shift therebetween, an upon detection of such a phase shift, indicating a presence of a fusion defect in the weld area. For smaller defects, the decrease in transmitted energy may not be apparent, however, voids acting as reflecting surfaces can still alter the shape of the signal. For example, a phase shift may be present due to reflection at a different angle and location compared to the external boundaries of the metal. Furthermore, certain modes may be more susceptible to the defect depending on the location and angle within the weld. FIG. 5 shows examples of time domain signals obtained from one sample containing defects, and two samples with no defects observed. In simple terms, the shape of the measured time domain signal is compared to a calibration sample, where a sufficient difference in signal will trigger a defect alert at that position. In mathematical terms, different quantification methods may be leveraged, where the choice of method is influenced by tolerances of the welding environment. In a first example, the similarity between the measured and reference signals is quantified by calculating the Pearson product-moment correlation coefficient. This coefficient is a single value that is then compared to a threshold. However, if the generation focusing lens is angled due to geometric constraints of the application, and if the distance between the lens and generation surfaces changes due to environmental conditions such as strain in the welding machine or weld base material, then the distance travelled by the ultrasonic wave to the detection spots will be altered. Such a scenario would cause a shift in the signal irrespective of any defects. With this in mind, instead of comparing time domain signals directly, the signals can also be shifted slightly in time and the similarity compared for each shift. This is done by calculating the cross-correlation (i.e., “sliding dot product”), which quantifies the similarity of signals as a function of lag. The maximum of the cross-correlation is then obtained and compared to a threshold value.

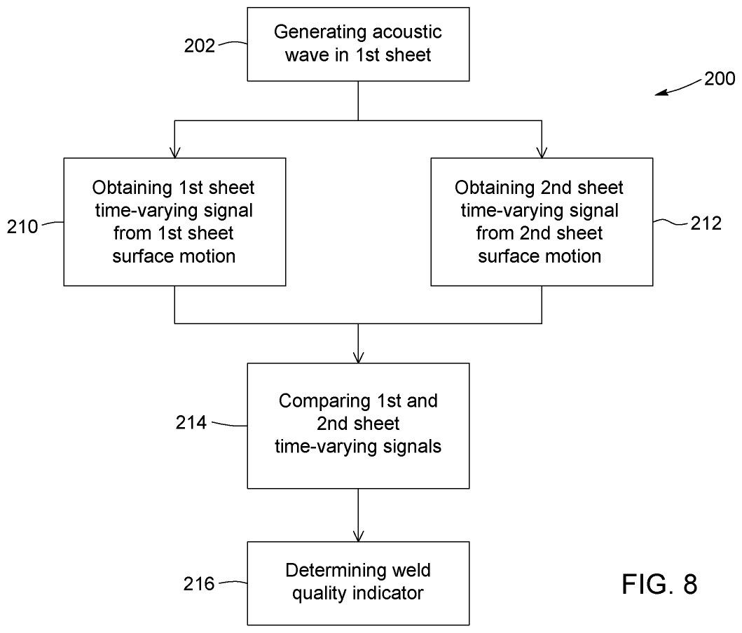

Referring to FIG. 8, a method 200 for inspecting a weld area between a first and a second metallic sheet according to another aspect is shown.

The method 200 includes a step of generating 202 an acoustic wave in the first metallic sheet for propagation towards the second metallic sheet across the weld area. This may for example be accomplished by impinging a pulsed laser beam on a generation spot on or in the first metallic sheet.

The method 200 further includes a step of obtaining 210 a first sheet time-varying signal representative of a surface motion at a first sheet detection location in the first metallic sheet. By way of example, this step may involve propagating a generated-wave detection light beam along a first sheet illumination path towards the first sheet detection location; receiving, in a generated-wave interferometer, a portion of the generated-wave detection light beam from the first sheet detection light source and a portion of the generated-wave detection light beam reflected on a top surface of the first metal sheet and travelling along a first sheet collection path; and detecting the first sheet time-varying signal as produced by the generated-wave interferometer.

The method 200 also includes a step of obtaining 212 a second sheet time-varying signal representative of a surface motion at a second sheet detection location in the second metallic sheet, By way of example, this step may involve propagating a transmitted-wave detection light beam along a second sheet illumination path towards the second sheet detection location; receiving, in a transmitted-wave interferometer, a portion of the transmitted-wave detection light beam from the second sheet detection laser source and a portion of the transmitted-wave detection light beam reflected on a top surface of the second metal sheet and travelling along a second sheet collection path; and detecting the second sheet time-varying signal as produced by the transmitted-wave interferometer.

The method finally includes a step of d) determining 216 a weld quality indicator based on a comparing 214 of said first and second sheet time-varying signals. In some implementations, such a comparison may involve determining a total transmitted energy into the second metallic sheet from a comparison of the first and second time-varying signal, and comparing said total transmitted energy to a calibrated transmitted energy threshold, and if said total transmitted energy is lower than the calibrated transmitted energy threshold, indicating a presence of a fusion defect in the weld area. In other implementations, the comparison of the first and second sheet time-varying signals may include comparing the first and a second sheet time-varying signals to detect a phase shift therebetween, an upon detection of said phase shift, indicating a presence of a fusion defect in the weld area.

### System

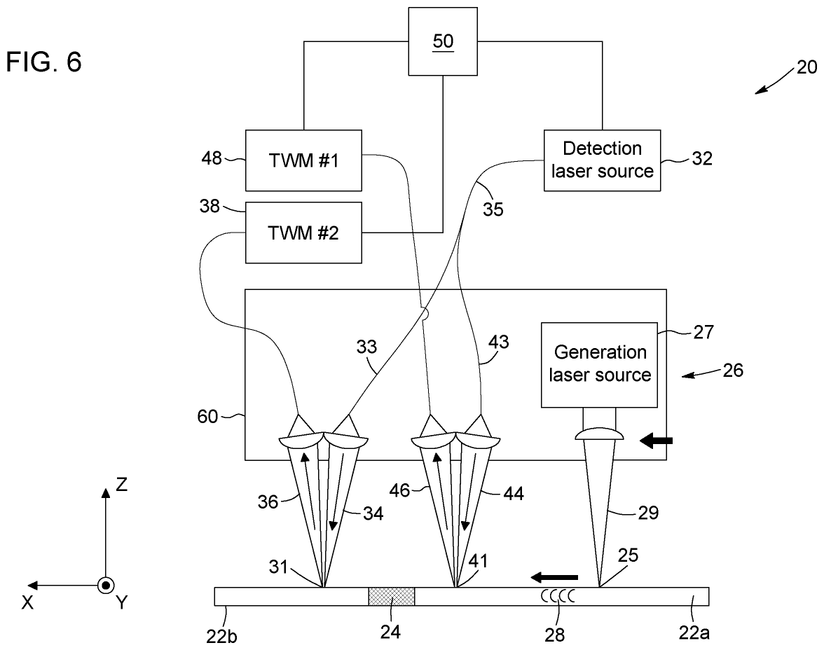

With reference to FIG. 6, in accordance with another aspect, there is provided a system 20 for inspecting a weld area 24 between a first and a second metallic sheets 22a, 22b.

The system first includes an acoustic wave generator 26 for generating an acoustic wave 28 in the first metallic sheet 22a for propagation towards the second metallic sheet 22b across the weld area 24. The acoustic wave generator 26 preferably includes a wave generation laser source 27 emitting a pulsed laser beam 29 impinging on a generation spot 25 on or in the first metal sheet 22a. Preferably, the pulses of the pulsed laser beam 29 may have a pulse width of the order of one or more nanoseconds. By way of example, the wave generation laser source 27 may be embodied by any pulsed laser having a pulse width short enough and energy per pulse high enough to trigger an acoustic wave by either thermal expansion (thermo-elastic generation) or by material removal (ablation generation). By way of example, such lasers may be embodied by actively or passively q-switched solid-state lasers, fiber lasers, gas lasers or mode-locked lasers. As will be readily understand by one skilled in the art, additional optical and/or optomechanical components may be provided in conjunction with the acoustic wave generator 26 to shape, focus direct or otherwise affect the pulsed laser beam 29 in view of its desired properties at the generation spot 25.

The weld inspection system 20 further includes a second sheet acoustic detection assembly 30. The second sheet acoustic detection assembly may be configured to obtain a second sheet time-varying signal representative of a surface motion at a second sheet detection location 31 in the second metallic sheet. In some implementations, the second sheet acoustic detection assembly 30 is positioned to measure surface motion at the second sheet detection location 31 in the second metallic sheet 22b, after the weld zone 24, thereby obtaining information on a portion of the acoustic wave transmitted through the weld area 24.

In some implementations the second sheet acoustic detection assembly 30 includes a second sheet detection laser source 32 configured to generate a transmitted-wave detection light beam 33 propagating along a second sheet illumination path 34 towards the second sheet detection location 31. The second sheet acoustic detection assembly 30 further includes a transmitted-wave interferometer 38 receiving a portion of the transmitted-wave detection light beam from the second sheet detection laser source and a portion of the transmitted-wave detection light beam 33 reflected on the top surface 23b of the second metal sheet 22b and travelling along a second sheet collection path 36. In some variants, the transmitted-wave interferometer 38 is embodied by a two-wave mixing interferometer (TWM), and may have any suitable configuration. By way of example, the TWM may be a photorefractive (holographic) interferometer, a Michelson interferometer, a Sagnac interferometer, or the like. The second sheet acoustic detection assembly 30 further includes a photodetector coupled to the transmitted wave interferometer 38 and producing a second sheet time-varying signal proportional to an out-of-plane displacement of the top surface of the second metallic sheet 22b. In some implementations, the photodetector is incorporated in the TWM, where the light interferes on the photodetector to produce a voltage proportional to the out of plane displacement of the second metallic sheet 22b.

As mentioned above, in implementations where generation is inconsistent, a comparison of the acoustic wave before and after the weld may be of interest. In such implementations, the weld inspection system 20 may further includes a first sheet acoustic detection assembly 40. The first sheet acoustic detection assembly 40 may be configured to obtain a first sheet time-varying signal representative of a surface motion at a first sheet detection location 41 in the first metallic sheet. In some implementations, the first sheet acoustic detection assembly 41 is positioned to measure surface motion at the first sheet detection location 41 in the first metallic sheet 22a, before the weld zone 24, thereby obtaining information on the acoustic wave as propagating in the first metallic sheet 22a.

In some implementations the first sheet acoustic detection assembly 40 includes a first sheet detection laser source 32 configured to generate a generated-wave detection light beam 43 propagating along a first sheet illumination path 44 towards the first sheet detection location 41. The first sheet acoustic detection assembly 40 further includes a generated-wave interferometer 48 receiving a portion of the generated-wave detection light beam from the first sheet detection light source and a portion of the generated-wave detection light beam 43 reflected on the top surface 23a of the first metal sheet 22a and travelling along a first sheet collection path 46. In some variants, the generated-wave interferometer 48 is embodied by a two-wave mixing interferometer (TWM) and may have any suitable configuration. By way of example, the TWM may be a photorefractive (holographic) interferometer, a Michelson interferometer, a Sagnac interferometer, or the like. The first sheet acoustic detection assembly 40 further includes a photodetector coupled to the generated wave interferometer 48 and producing a first sheet time-varying signal proportional to an out-of-plane displacement of the top surface of the first metallic sheet 22a. In some implementations, the photodetector is incorporated in the TWM, where the light interferes on the photodetector to produce a voltage proportional to the out of plane displacement of the first metallic sheet 22a.

In some embodiments, such as shown by way of example in FIG. 6, a single detection laser source 32 may be used to generate a source detection light beam 35 which can be divided into the transmitted-wave detection light beam 33 and the generated-wave detection light beam 43. The detection laser source 32 may for example be embodied by a quasi-cw (continuous wave) laser, a solid-state laser or a fibered laser, for example delivering continuous single frequency power above 1 watt. The detection laser source 32 may also be embodied by an amplified low power single frequency laser for which the amplified power is above 50 watts for the duration of the ultrasonic phenomenon. This last option may be preferable when the target is moving fast or if the working distance is of a longer range, thus requiring more detection laser power.

The weld inspection system 20 further includes a processor 50 configured to determine a frequency-dependent attenuation of the acoustic wave from a frequency contents of the acoustic wave in the second metallic sheet 22a, and determine a weld quality indicator based thereon, and/or to determine a weld quality indicator based on a comparison of said first and second sheet time-varying signals.

In some implementations, the processor is configured to analyse the second sheet time-varying signal in the frequency domain to determine the frequency-dependent attenuation of the acoustic wave. In the illustrated embodiment, the processor 50 is in communication with the both detection assemblies 30 and 40 so as to receive therefrom information related to surface motion detection in the corresponding metallic sheet 22b, 22a. The processor 50 is configured to calculate the frequency-dependent attenuation of the acoustic wave in the second metallic sheet 22a as explained above. Preferably, the system 20 uses average grain size in the weld nugget as an indicator of the overall weld nugget size, by characterizing the frequency-dependent attenuation of the ultrasonic waves passing through the weld zone 24.

In some variants, analysing the second sheet time-varying signal in the frequency domain involves calculating a power spectral density curve of the second sheet time-varying signal, fitting the power spectral density curve to a power law, and determining an exponent value of this power law determining the weld quality indicator then includes comparing the exponent value of the power law to a calibrated exponent threshold, and, if this exponent value is greater than the calibrated exponent threshold, indicating a presence of large grains in the weld area.

In other variants, the processor is configured to analyse the first and second sheet time-varying signals in the frequency domain to determine the frequency-dependent attenuation of the acoustic wave. In such cases, analysing the first and second sheet time-varying signals in the frequency domain may involve calculating a first and a second power spectral density curve of the first and second time-varying signals, respectively, identifying a plurality of vibration modes in the first and second spectral density curves, and determining an amplitude ratio of each of these vibration modes in the first metallic sheet and in the second metallic sheet. The amplitude ratio is then fitted as a function of frequency to a power law, and an exponent value of this power law is determined. The weld quality indicator is then determined by comparing the exponent value of the power law to a calibrated exponent threshold, and if this exponent value is greater than the calibrated exponent threshold, the presence of large grains in the weld area is indicated.

In some implementations, the processor is configured to compare the first and the second sheet time-varying signals to detect a phase shift therebetween. As explained above, upon detection of such a phase shift, the presence of a fusion defect in the weld area is indicated.

In some variants, the processor may also determine the presence of significant lack of fusion based on the detected surface motion in the first metallic sheet. Such a lack of fusion causes a measurable acoustic pulse reflected from the void that travels backwards, separated in time from the forward travelling wave. Observation of the reflected wave before the weld, in addition to the reduced total energy after the weld, enhances the detection robustness by providing two metrics for identifying lack of fusion. In some implementations, the processor is configured to determine a total transmitted energy into the second metallic sheet from a comparison of the first and second time-varying signal, and compare this total transmitted energy to a calibrated transmitted energy threshold. If the total transmitted energy is lower than the calibrated transmitted energy threshold, the presence of a fusion defect in the weld area is indicated.

It will be readily understood that the system 20 may include additional optical and/or optomechanical components to shape, focus, carry, direct or otherwise affect the various light beams propagating through the system, such as lenses, mirrors, optical fiber and the like.

In some variants, some or all of the components of the system 20 may integrated in a probe 60. The probe may have a frame or casing in which are supported and mounted the different lasers, optical components such as lenses, etc. In some variants the probe may be physically connected or integrated into the welding probe used to make the weld. Advantageously, the system 20 and associated method may be used in real-time to inspect the weld just as it is made. Scanning means may also be provided for the online inspection of the weld along a length thereof.

As will be readily understood by one skilled in the art, the system of FIG. 6 may be used to carry out either one of the methods of FIGS. 7 and 8, or both of these methods. It will however be readily understood that this embodiment of shown by way of example only, and that other systems may be configured to carry out only one of the methods of FIG. 7 or 8 without departing from the scope of protection. For example, in one implementation a system similar to the one shown in FIG. 6 but omitting

Of course, numerous modifications could be made to the embodiments described above without departing from the scope of protection.

1. A method for inspecting a weld area between a first and a second metallic sheet, comprising:
a) generating an acoustic wave in the first metallic sheet for propagation towards the second metallic sheet across the weld area;
b) measuring a frequency content of the acoustic wave in the second metallic sheet;
c) determining a frequency-dependent attenuation of the acoustic wave from the measured frequency content of the acoustic wave in the second metallic sheet; and
d) determining a weld quality indicator based on said frequency-dependent attenuation.

2. The method according to claim 1, wherein:
measuring a frequency content of the acoustic wave in the second metallic sheet comprises obtaining a second sheet time-varying signal proportional to an out-of-plane displacement of a top surface of the second metallic sheet through time-domain light interferometry; and
determining a frequency-dependent attenuation of the acoustic wave comprises analysing said second sheet time-varying signal in the frequency domain.

3. The method according to claim 2, wherein analysing said second sheet time-varying signal in the frequency domain comprises calculating a power spectral density curve of said second sheet time-varying signal.

4. The method according to claim 3, wherein analysing said second sheet time-varying signal in the frequency domain comprises fitting the power spectral density curve to a power law, and determining an exponent value of said power law.

5. The method according to claim 4, wherein the weld quality indicator is a weld nugget size, and wherein determining said weld quality indicator comprises comparing said exponent value of the power law to a calibrated exponent threshold, and, if said exponent value is greater than the calibrated exponent threshold, indicating a presence of large grains in the weld area.

6. The method according to claim 1, further comprising measuring a frequency content of the acoustic wave in the first metallic sheet, and wherein determining the frequency-dependent attenuation of the acoustic wave comprises comparing the measured frequency contents of the acoustic wave in the first and second metallic sheets.

7. The method according to claim 6, wherein:
measuring a frequency content of the acoustic wave in the first and second metallic sheet comprises obtaining a first and a second sheet time-varying signal each proportional to an out-of-plane displacement of a top surface of the respective one of the first and second metallic sheets through time-domain light interferometry; and
determining a frequency-dependent attenuation of the acoustic wave comprises analysing said first and second sheet time-varying signals in the frequency domain.

8. The method according to claim 7, wherein analysing said first and second sheet time-varying signals in the frequency domain comprises calculating a first and a second power spectral density curve of said first and second sheet time-varying signals, respectively.

9. The method according to according to claim 8, wherein analysing said first and second sheet time-varying signals in the frequency domain comprises:
identifying a plurality of vibration modes in the first and second spectral density curves;
determining an amplitude ratio of each of said vibration modes in the first metallic sheet and in the second metallic sheet; and
fitting the amplitude ratio as a function of frequency to a power law, and determining an exponent value of said power law.

10. The method according to claim 9, wherein:
the weld quality indicator is a weld nugget size;
determining said weld quality indicator comprising comparing said exponent value of the power law to a calibrated exponent threshold; and
if said exponent value is greater than the calibrated exponent threshold, indicating a presence of large grains in the weld area.

11. The method according to claim 3, further comprising determining a total transmitted energy into the second metallic sheet through integration of the power spectral density curve of the second sheet time-varying signal, comparing said total transmitted energy to a calibrated transmitted energy threshold, and if said total transmitted energy is lower than the calibrated transmitted energy threshold, indicating a presence of a fusion defect in the weld area.

12. The method according to claim 8, further comprising:
determining a total transmitted energy into the second metallic sheet through a comparison of the second power spectral density curve and the first spectral density curve; and
comparing said total transmitted energy to a calibrated transmitted energy threshold, and if said total transmitted energy is lower than the calibrated transmitted energy threshold, indicating a presence of a fusion defect in the weld area.

13. The method according to claim 8, further comprising comparing the first and a second sheet time-varying signals to detect a phase shift therebetween, an upon detection of said phase shift, indicating a presence of a fusion defect in the weld area.

14. A system for inspecting a weld area between a first and a second metallic sheets, comprising:
an acoustic wave generator for generating an acoustic wave in the first metallic sheet for propagation towards the second metallic sheet across the weld area;
a second sheet acoustic detection assembly positioned to measure a surface motion at a second sheet detection location in the second metallic sheet and configured to measure a frequency content of the acoustic wave in the second metallic sheet, the second sheet acoustic detection assembly comprising a transmitted-wave interferometer; and
a processor configured to determine a frequency-dependent attenuation of the acoustic wave from a frequency contents of the acoustic wave in the second metallic sheet, and determine a weld quality indicator based on said frequency contents of the acoustic wave in the second metallic sheet.

15. The system according to claim 14, wherein the acoustic wave generator comprises a wave generation laser source emitting a pulsed laser beam impinging on a generation spot on or in the first metallic sheet.

16. The system according to claim 14, wherein the second sheet acoustic detection assembly comprises:
a second sheet detection laser source configured to generate a transmitted-wave detection light beam propagating along a second sheet illumination path towards the second sheet detection location, the transmitted-wave interferometer receiving a portion of the transmitted-wave detection light beam from the second sheet detection laser source and a portion of the transmitted-wave detection light beam reflected on a top surface of the second metal sheet and travelling along a second sheet collection path; and
a photodetector coupled to the transmitted wave interferometer and producing a second sheet time-varying signal proportional to an out-of-plane displacement of the top surface of the second metallic sheet.

17. The system according to claim 16, wherein the processor is configured to analyse said second sheet time-varying signal in the frequency domain to determine the frequency-dependent attenuation of the acoustic wave.

18. The system according to claim 17, wherein analysing said second sheet time-varying signal in the frequency domain comprises:
calculating a power spectral density curve of said second sheet time-varying signal and
fitting the power spectral density curve to a power law, and determining an exponent value of said power law; and
wherein the weld quality indicator is a weld nugget size; and
wherein determining said weld quality indicator comprises comparing said exponent value of the power law to a calibrated exponent threshold, and, if said exponent value is greater than the calibrated exponent threshold, indicating a presence of large grains in the weld area.

19. The system according to claim 16, further comprising a first sheet acoustic detection assembly positioned to measure surface motion at a first sheet detection location in the first metallic sheet, before the weld zone, thereby obtaining information on the acoustic wave as propagating in the first metallic sheet.

20. The system according to claim 19, wherein the first sheet acoustic detection assembly comprises:
a first sheet detection laser source configured to generate a generated-wave detection light beam propagating along a first sheet illumination path towards the first sheet detection location;
a generated-wave interferometer receiving a portion of the generated-wave detection light beam from the first sheet detection light source and a portion of the generated-wave detection light beam reflected on a top surface of the first metal sheet and travelling along a first sheet collection path; and
a photodetector coupled to the generated-wave interferometer and producing a first sheet time-varying signal proportional to an out-of-plane displacement of the top surface of the first metallic sheet.

21. The system according to claim 20, wherein the processor is configured to analyse said first and second sheet time-varying signals in the frequency domain to determine the frequency-dependent attenuation of the acoustic wave.

22. The system according to claim 21, wherein analysing said first and second sheet time-varying signals in the frequency domain comprises:
calculating a first and a second power spectral density curve of said first and second time-varying signals, respectively;
identifying a plurality of vibration modes in the first and second spectral density curves;
determining an amplitude ratio of each of said vibration modes in the first metallic sheet and in the second metallic sheet; and
fitting the amplitude ratio as a function of frequency to a power law, and determining an exponent value of said power law;
wherein the weld quality indicator is a weld nugget size; and
wherein determining said weld quality indicator comprising comparing said exponent value of the power law to a calibrated exponent threshold, and if said exponent value is greater than the calibrated exponent threshold, indicating a presence of large grains in the weld area.

23. A system for inspecting a weld area between a first and a second metallic sheets, comprising:
an acoustic wave generator for generating an acoustic wave in the first metallic sheet for propagation towards the second metallic sheet across the weld area;
a first sheet acoustic detection assembly configured to obtain a first sheet time-varying signal representative of a surface motion at a first sheet detection location in the first metallic sheet;
a second sheet acoustic detection assembly configured to obtain a second sheet time-varying signal representative of a surface motion at a second sheet detection location in the second metallic sheet; and
a processor configured to determine a weld quality indicator based on a comparison of said first and second sheet time-varying signals.

24. The system according to claim 23, wherein the acoustic wave generator comprises a wave generation laser source emitting a pulsed laser beam impinging on a generation spot on or in the first metallic sheet.

25. The system according to claim 23, wherein the first sheet acoustic detection assembly comprises:
a first sheet detection laser source configured to generate a generated-wave detection light beam propagating along a first sheet illumination path towards the first sheet detection location;
a generated-wave interferometer receiving a portion of the generated-wave detection light beam from the first sheet detection light source and a portion of the generated-wave detection light beam reflected on a top surface of the first metal sheet and travelling along a first sheet collection path; and
a photodetector coupled to the generated-wave interferometer and producing the first sheet time-varying signal.

26. The system according to claim 23, wherein the second sheet acoustic detection assembly comprises:
a second sheet detection laser source configured to generate a transmitted-wave detection light beam propagating along a second sheet illumination path towards the second sheet detection location;
a transmitted-wave interferometer receiving a portion of the transmitted-wave detection light beam from the second sheet detection laser source and a portion of the transmitted-wave detection light beam reflected on a top surface of the second metal sheet and travelling along a second sheet collection path; and
a photodetector coupled to the transmitted-wave interferometer and producing the second sheet time-varying signal.

27. The system according to claim 23, wherein the processor is configured to:
determine a total transmitted energy into the second metallic sheet from a comparison of the first and second time-varying signal, and
compare said total transmitted energy to a calibrated transmitted energy threshold, and if said total transmitted energy is lower than the calibrated transmitted energy threshold, indicating a presence of a fusion defect in the weld area.

28. The system according to claim 23, wherein the processor is configured to compare the first and the second sheet time-varying signals to detect a phase shift therebetween, an upon detection of said phase shift, indicating a presence of a fusion defect in the weld area.

29. A method for inspecting a weld area between a first and a second metallic sheet, comprising:
a) generating an acoustic wave in the first metallic sheet for propagation towards the second metallic sheet across the weld area;
b) obtaining a first sheet time-varying signal representative of a surface motion at a first sheet detection location in the first metallic sheet;
c) obtaining a second sheet time-varying signal representative of a surface motion at a second sheet detection location in the second metallic sheet; and
d) determining a weld quality indicator based on a comparison of said first and second sheet time-varying signals.

30. The method according to claim 29, wherein generating an acoustic wave comprises impinging a pulsed laser beam on a generation spot on or in the first metallic sheet.

31. The method according to claim 29, wherein obtaining a first sheet time-varying signal comprises:
propagating a generated-wave detection light beam along a first sheet illumination path towards the first sheet detection location;
receiving, in a generated-wave interferometer, a portion of the generated-wave detection light beam from the first sheet detection light source and a portion of the generated-wave detection light beam reflected on a top surface of the first metal sheet and travelling along a first sheet collection path; and
detecting the first sheet time-varying signal as produced by the generated-wave interferometer.

32. The method according to claim 29, wherein obtaining a second sheet time-varying signal comprises:
propagating a transmitted-wave detection light beam along a second sheet illumination path towards the second sheet detection location;
receiving, in a transmitted-wave interferometer, a portion of the transmitted-wave detection light beam from the second sheet detection laser source and a portion of the transmitted-wave detection light beam reflected on a top surface of the second metal sheet and travelling along a second sheet collection path; and
detecting the second sheet time-varying signal as produced by the transmitted-wave interferometer.

33. The method according to claim 29, wherein determining a weld quality indicator based on a comparison of said first and second sheet time-varying signals comprises:
determining a total transmitted energy into the second metallic sheet from a comparison of the first and second time-varying signal, and
comparing said total transmitted energy to a calibrated transmitted energy threshold, and if said total transmitted energy is lower than the calibrated transmitted energy threshold, indicating a presence of a fusion defect in the weld area.

34. The method according to claim 29, wherein determining a weld quality indicator based on a comparison of said first and second sheet time-varying signals comprises comparing the first and a second sheet time-varying signals to detect a phase shift therebetween, an upon detection of said phase shift, indicating a presence of a fusion defect in the weld area.
